(19) United States
(12) Patent Application Publication
(10) Pub. No.: US 2021/0235097 A1
(43) Pub. Date: Jul. 29, 2021

(54) TRANSFORM METHOD AND INVERSE TRANSFORM METHOD FOR PICTURE BLOCK AND APPARATUS

(71) Applicants: Huawei Technologies Co., Ltd., Shenzhen (CN); TSINGHUA UNIVERSITY, Beijing (CN)

(72) Inventors: Quanhe YU, Beijing (CN); Jianhua ZHENG, Shenzhen (CN); Liqiang WANG, Beijing (CN); Yun HE, Beijing (CN)

(21) Appl. No.: 17/230,699

(22) Filed: Apr. 14, 2021

Related U.S. Application Data
(63) Continuation of application No. PCT/CN2019/110355, filed on Oct. 10, 2019.

(30) Foreign Application Priority Data
Oct. 15, 2018 (CN) 201811198621.X

(51) Int. Cl. H04N 19/176; H04N 19/60; H04N 19/172; H04N 19/184

(52) U.S. Cl. CPC H04N 19/176; H04N 19/60; H04N 19/13; H04N 19/184; H04N 19/172

(57) ABSTRACT

This application provides a transform method and an inverse transform method for a picture block, and an apparatus. The transform method for a picture block in this application includes: obtaining a to-be-encoded picture block in a to-be-processed picture, where the to-be-encoded picture block is an object on which encoding is performed; splitting the to-be-encoded picture block to obtain a plurality of picture subblocks; and transforming at least one of the picture subblocks. In this application, picture encoding efficiency is improved.

### CROSS-REFERENCE TO RELATED APPLICATIONS

This application is a continuation of International Application No. PCT/CN2019/110355, filed on Oct. 10, 2019, which claims priority to Chinese Patent Application No. 201811198621.X, filed on Oct. 15, 2018. The disclosures of the aforementioned applications are hereby incorporated by reference in their entireties.

### TECHNICAL FIELD

This application relates to picture processing technologies, and in particular, to a transform method and an inverse transform method for a picture block, and an apparatus.

### BACKGROUND

A picture block-based hybrid video coding scheme is used in a modern video coding standard, where an encoding process includes (intra and inter) prediction, transform, quantization, and entropy encoding on each picture block in a picture frame, and a decoding process includes entropy decoding, dequantization, inverse transform, and (intra and inter) prediction on a picture block in a picture frame. A derivative mode is a new block split mode. A plurality of block split modes may be derived based on one picture block, and a picture subblock is actually a split result of the picture block.

Currently, in a video coding process, transform and inverse transform are performed based on a picture subblock obtained through splitting. Consequently, coding efficiency is low.

### SUMMARY

This application provides a transform method and an inverse transform method for a picture block, and an apparatus, to improve picture coding efficiency.

According to a first aspect, this application provides a transform method for a picture block. For different to-be-encoded picture blocks in a to-be-processed picture, the to-be-encoded picture block is split into a plurality of picture subblocks, and at least one of the plurality of picture subblocks is transformed. In this way, transform performed on the to-be-encoded picture block is flexible and diversified, and complies with a picture feature of the to-be-encoded picture block. This improves picture coding efficiency.

A derivative mode is a new block split mode. A plurality of block split modes may be derived based on one picture block, and a picture subblock is actually a split result of the picture block. A picture block in a picture is an object on which encoding is performed. A plurality of block split methods may be used to split the picture block. A first split method is to split the picture block by using a horizontal line and/or a vertical line. In this split method, a plurality of split effects may be derived based on different combinations of four horizontal and vertical lines. A second split method is to split the picture block by using a horizontal line. In this split method, a plurality of split effects may be derived based on different combinations of a plurality of horizontal lines. A third split method is to split the picture block by using a vertical line. In this split method, a plurality of split effects may be derived based on different combinations of a plurality of vertical lines.

In an embodiment, an encoding apparatus splits the to-be-encoded picture block to obtain M picture subblocks, where M is an integer greater than 1; and transforms a to-be-transformed picture block obtained after N neighboring picture subblocks in the M picture subblocks are combined, where N is an integer less than or equal to M and greater than or equal to 1.

In an embodiment, that the encoding apparatus transforms the to-be-transformed picture block obtained after N neighboring picture subblocks in the M picture subblocks are combined is any one of the following three methods: transforming each of the M picture subblocks; transforming a to-be-transformed picture block obtained after at least two of the M picture subblocks are combined; or transforming a to-be-transformed picture block obtained after all the M picture subblocks are combined.

In an embodiment, the encoding apparatus may further determine a block split method used for the to-be-encoded picture block; determine, from the three methods, a transform method used for the at least one of the picture subblocks; and add identification information in a bitstream of the picture, where the identification information is used to indicate the block split method used for the to-be-encoded picture block and the transform method used for the at least one of the picture subblocks.

In an embodiment, the encoding apparatus may vertically split the to-be-encoded picture block to obtain the plurality of picture subblocks, and/or horizontally split the to-be-encoded picture block to obtain the plurality of picture subblocks.

In an embodiment, the encoding apparatus determines a method with a lowest operation cost in the three methods as the transform method used for the at least one of the picture subblocks. Alternatively, the encoding apparatus determines, from the three methods and based on a result of comparison between a length and/or a width of the to-be-encoded picture block and a specified threshold, the transform method used for the at least one of the picture subblocks.

According to a second aspect, this application provides an inverse transform method for a picture block. For different to-be-decoded picture blocks in a to-be-processed picture, a block split method and a transform method that are used for the to-be-decoded picture block in the picture are determined based on identification information obtained from a bitstream. The to-be-decoded picture block is split according to the block split method to obtain a plurality of picture subblocks. Then, at least one of the picture subblocks is inversely transformed according to the transform method. In this way, inverse transform performed on the picture block is flexible and diversified, and complies with a picture feature of the picture block. This improves picture coding efficiency.

In an embodiment, a decoding apparatus splits the to-be-decoded picture block according to the block split method to obtain M picture subblocks, where M is an integer greater than 1; and inversely transforms, according to the transform method, a to-be-inversely transformed picture block obtained after N neighboring picture subblocks in the M picture subblocks are combined, where N is an integer less than or equal to M and greater than or equal to 1.

In an embodiment, that the decoding apparatus inversely transforms, according to the transform method, the to-be-inversely transformed picture block obtained after N neighboring picture subblocks in the M picture subblocks are combined is any one of the following three methods: inversely transforming each of the M picture subblocks; inversely transforming a to-be-inversely transformed picture block obtained after at least two of the M picture subblocks are combined; or inversely transforming a to-be-inversely transformed picture block obtained after all the M picture subblocks are combined.

In an embodiment, that the decoding apparatus splits the to-be-decoded picture block according to the block split method to obtain the plurality of picture subblocks is any one of the following three methods: vertically splitting the to-be-decoded picture block to obtain the plurality of picture subblocks; horizontally splitting the to-be-decoded picture block to obtain the plurality of picture subblocks; or vertically and horizontally splitting the to-be-decoded picture block to obtain the plurality of picture subblocks.

In an embodiment, that the decoding apparatus inversely transforms the at least one of the picture subblocks according to the transform method is either of the following two methods: when the M picture subblocks are obtained by horizontally splitting the picture block, inversely transforming a to-be-inversely transformed picture block obtained after N neighboring picture subblocks in the M picture subblocks are vertically combined; or when the M picture subblocks are obtained by vertically splitting the picture block, inversely transforming a to-be-inversely transformed picture block obtained after N neighboring picture subblocks in the M picture subblocks are horizontally combined.

According to a third aspect, this application provides an encoding apparatus, including:

a first obtaining module, configured to obtain a to-be-encoded picture block in a to-be-processed picture, where the to-be-encoded picture block is an object on which encoding is performed;

a first split module, configured to split the to-be-encoded picture block to obtain a plurality of picture subblocks; and

a transform module, configured to transform at least one of the picture subblocks.

In an embodiment, the first split module is specifically configured to split the to-be-encoded picture block to obtain M picture subblocks, where M is an integer greater than 1.

The transform module is specifically configured to transform a to-be-transformed picture block obtained after N neighboring picture subblocks in the M picture subblocks are combined, where N is an integer less than or equal to M and greater than or equal to 1.

In an embodiment, the transform module is specifically configured to perform any one of the following three methods:

transforming each of the M picture subblocks;

transforming a to-be-transformed picture block obtained after at least two of the M picture subblocks are combined; or

transforming a to-be-transformed picture block obtained after all the M picture subblocks are combined.

In an embodiment, the encoding apparatus further includes:

a first determining module, configured to determine a block split method used for the to-be-encoded picture block, and determine, from the three methods, a transform method used for the at least one of the picture subblocks.

In an embodiment, the first determining module is further configured to add identification information in a bitstream of the picture. The identification information is used to indicate the block split method used for the to-be-encoded picture block and the transform method used for the at least one of the picture subblocks.

In an embodiment, the first split module is specifically configured to vertically split the to-be-encoded picture block to obtain the plurality of picture subblocks, and/or horizontally split the to-be-encoded picture block to obtain the plurality of picture subblocks.

In an embodiment, the first determining module is specifically configured to determine a method with a lowest operation cost in the three methods as the transform method used for the at least one of the picture subblocks.

In an embodiment, the first determining module is specifically configured to determine, from the three methods and based on a result of comparison between a length and/or a width of the to-be-encoded picture block and a specified threshold, the transform method used for the at least one of the picture subblocks.

According to a fourth aspect, this application provides a decoding apparatus, including:

a second obtaining module, configured to obtain a bitstream of a to-be-processed picture, and obtain identification information from the bitstream;

a second determining module, configured to determine, based on the identification information, a block split method and a transform method that are used for a to-be-decoded picture block in the picture, where the to-be-decoded picture block is an object on which decoding is performed;

a second split module, configured to split the to-be-decoded picture block according to the block split method to obtain a plurality of picture subblocks; and

an inverse transform module, configured to inversely transform at least one of the picture subblocks according to the transform method.

In an embodiment, the second split module is specifically configured to split the to-be-decoded picture block according to the block split method to obtain M picture subblocks, where M is an integer greater than 1.

The inverse transform module is specifically configured to inversely transform, according to the transform method, a to-be-inversely transformed picture block obtained after N neighboring picture subblocks in the M picture subblocks are combined, where N is an integer less than or equal to M and greater than or equal to 1.

In an embodiment, the inverse transform module is specifically configured to perform any one of the following three methods:

inversely transforming each of the M picture subblocks;

inversely transforming a to-be-inversely transformed picture block obtained after at least two of the M picture subblocks are combined; or

inversely transforming a to-be-inversely transformed picture block obtained after all the M picture subblocks are combined.

In an embodiment, the second split module is specifically configured to perform any one of the following three methods:

vertically splitting the to-be-decoded picture block to obtain the plurality of picture subblocks;

horizontally splitting the to-be-decoded picture block to obtain the plurality of picture subblocks; or

vertically and horizontally splitting the to-be-decoded picture block to obtain the plurality of picture subblocks.

In an embodiment, the inverse transform module is specifically configured to perform either of the following two methods:

when the M picture subblocks are obtained by horizontally splitting the picture block, inversely transforming a to-be-inversely transformed picture block obtained after N neighboring picture subblocks in the M picture subblocks are vertically combined; or

when the M picture subblocks are obtained by vertically splitting the picture block, inversely transforming a to-be-inversely transformed picture block obtained after N neighboring picture subblocks in the M picture subblocks are horizontally combined.

According to a fifth aspect, this application provides a picture processing device, including:

one or more processors, and

a memory, configured to store one or more programs.

When the one or more programs are executed by the one or more processors, the one or more processors are enabled to implement the transform method for a picture block according to the first aspect or the inverse transform method for a picture block according to the second aspect.

According to a sixth aspect, this application provides a computer-readable storage medium. The computer-readable storage medium stores instructions. When the instructions are run on a computer, the instructions are used to perform the transform method for a picture block according to the first aspect or the inverse transform method for a picture block according to the second aspect.

According to a seventh aspect, this application provides a computer program. When the computer program is executed by a computer, the computer program is used to perform the transform method for a picture block according to the first aspect or the inverse transform method for a picture block according to the second aspect.

### BRIEF DESCRIPTION OF DRAWINGS

FIG. 1 is a schematic flowchart of picture encoding;

FIG. 2 is a schematic flowchart of picture decoding;

FIG. 3 is a schematic diagram of an effect of an embodiment of a block split method that may be used in this application;

FIG. 4 is a flowchart of an embodiment of a transform method for a picture block according to this application;

FIG. 5 is a flowchart of an embodiment of an inverse transform method for a picture block according to this application;

FIG. 6 is a schematic structural diagram of Embodiment 1 of an encoding apparatus according to this application;

FIG. 7 is a schematic structural diagram of Embodiment 2 of an encoding apparatus according to this application;

FIG. 8 is a schematic structural diagram of an embodiment of a decoding apparatus according to this application; and

FIG. 9 is a schematic structural diagram of an embodiment of a picture processing device according to this application.

### DESCRIPTION OF EMBODIMENTS

To make the objectives, technical solutions, and advantages of this application clearer, the following clearly describes the technical solutions in this application with reference to the accompanying drawings in this application. Definitely, the described embodiments are merely a part rather than all of the embodiments of this application. All other embodiments obtained by a person of ordinary skill in the art based on the embodiments of this application without creative efforts shall fall within the protection scope of this application.

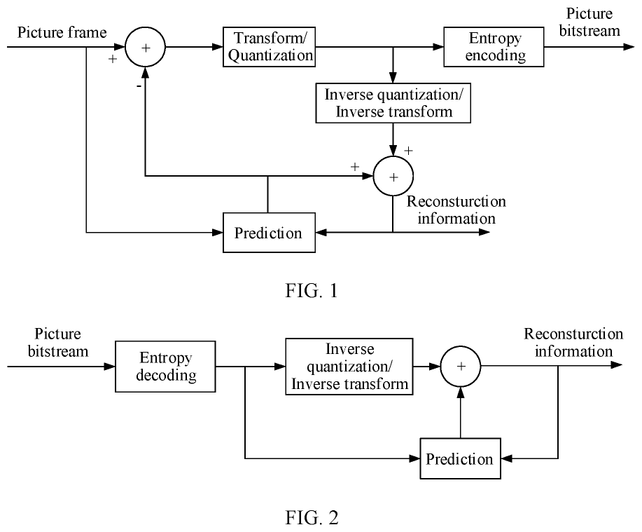

FIG. 1 is a schematic flowchart of picture encoding. As shown in FIG. 1, a picture block-based hybrid video encoding process includes (intra and inter) prediction, transform, quantization, and entropy encoding. To be specific, a residual signal is obtained after prediction is performed on a picture frame in an input video sequence, to remove redundancy. Then, prediction is performed by using encoded reconstruction information as reference information. Next, the residual signal is transformed to concentrate energy of the residual signal. Subsequently, quantization is performed. Finally, a picture bitstream is output after entropy encoding. The encoding process further includes a part of a decoding process. This is because the reconstruction information is used when intra prediction is performed. Therefore, after transform and quantization are performed, dequantization and inverse transform further need to be performed to obtain the reconstruction information.

FIG. 2 is a schematic flowchart of picture decoding. As shown in FIG. 2, a picture block-based hybrid video decoding process includes entropy decoding, dequantization, inverse transform, and (intra and inter) prediction. To be specific, coding information such as a quantized coefficient and a coding mode is obtained after entropy decoding is performed on a picture bitstream. A residual signal is obtained after dequantization and inverse transform are performed on the quantized coefficient. Other coding information is used to perform prediction consistent with that during encoding. Generated prediction information is added to the residual signal to obtain final reconstruction information. In addition, the generated reconstruction information is further used for intra prediction during subsequent decoding.

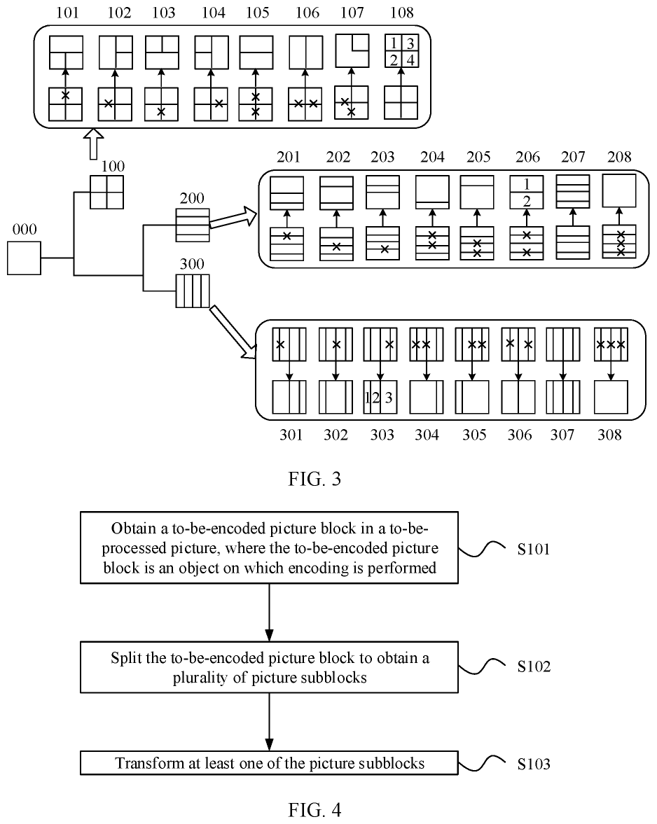

A derivative mode is a new block split mode. A plurality of block split modes may be derived based on one picture block, and a picture subblock is actually a split result of the picture block. FIG. 3 is a schematic diagram of an effect of an embodiment of a block split method that may be used in this application. As shown in FIG. 3, a picture block 000 in a picture is an object on which encoding is performed, and a plurality of block split methods may be used to split the picture block 000. A first split method is to split the picture block 000 by using a horizontal line and/or a vertical line, to obtain a split effect shown in a picture block 100. In this split method, split effects that include but are not limited to split effects shown in picture blocks 101 to 108 may be derived based on different combinations of four horizontal and vertical lines. A second split method is to split the picture block 000 by using a horizontal line, to obtain a split effect shown in a picture block 200. In this split method, split effects that include but are not limited to split effects shown in picture blocks 201 to 208 may be derived based on different combinations of three horizontal lines. A third split method is to split the picture block 000 by using a vertical line, to obtain a split effect shown in a picture block 300. In this split method, split effects that include but are not limited to split effects shown in picture blocks 301 to 308 may be derived based on different combinations of three vertical lines. It should be noted that FIG. 3 shows a derivative effect of a square picture block 000. Alternatively, derivation may be performed on a non-square picture block. This is not specifically limited in this application.

Based on any split effect shown in the foregoing embodiments of the block split method, this application provides a transform or inverse transform method for a picture block. For different to-be-processed picture blocks (namely, to-be-encoded picture blocks or to-be-decoded picture blocks) in a to-be-processed picture, the to-be-processed picture block is split to obtain a plurality of picture subblocks, and at least one of the plurality of picture subblocks is transformed or inversely transformed. In this way, transform or inverse transform performed on the to-be-processed picture block is flexible and diversified, and complies with a picture feature of the to-be-processed picture block. This improves picture coding efficiency.

FIG. 4 is a flowchart of an embodiment of a transform method for a picture block according to this application. As shown in FIG. 4, the method in this embodiment is performed by an encoding apparatus, and may include the following steps.

Step S101: Obtain a to-be-encoded picture block in a to-be-processed picture, where the to-be-encoded picture block is an object on which encoding is performed.

In this application, encoding is performed based on a to-be-encoded picture block. The to-be-encoded picture block may be a square or a non-square. The to-be-encoded picture block is a largest transform unit in this application.

Step S102: Split the to-be-encoded picture block to obtain a plurality of picture subblocks.

In this application, the encoding apparatus may obtain M picture subblocks (where M is an integer greater than 1) by splitting the to-be-encoded picture block. The picture subblocks may be obtained through a derivative split or a non-derivative split. The split effects shown in FIG. 3 are obtained by performing the derivative split on the picture block by separately using three block split methods. The three block split methods include: vertically splitting the to-be-encoded picture block to obtain the M picture subblocks (for example, a plurality of picture subblocks separately shown in the picture blocks 301 to 308); horizontally splitting the to-be-encoded picture block to obtain the M picture subblocks (for example, a plurality of picture subblocks separately shown in the picture blocks 201 to 208); or vertically and horizontally splitting the to-be-encoded picture block to obtain the M picture subblocks (for example, a plurality of picture subblocks separately shown in the picture blocks 101 to 108).

Step S103: Transform at least one of the picture subblocks.

In this application, transform is performed on a to-be-transformed picture block obtained after N neighboring picture subblocks in the M picture subblocks obtained in step S102 are combined (where N is an integer less than or equal to M and greater than or equal to 1).

In an embodiment, the transform may be any one of the following three methods: transforming each of the M picture subblocks; transforming a to-be-transformed picture block obtained after at least two of the M picture subblocks are combined; or transforming a to-be-transformed picture block obtained after all the M picture subblocks are combined. To be specific, the encoding apparatus may separately transform each of the M picture subblocks. For example, in the picture block 206 in FIG. 3, the encoding apparatus may separately transform picture subblocks 1 and 2 obtained through splitting. Alternatively, the encoding apparatus may transform a picture block obtained after some (N) of the M picture subblocks are combined. For example, in the picture block 108 in FIG. 3, the encoding apparatus may transform a picture block obtained after picture subblocks 1 and 2 are combined, and transform a picture block obtained after picture subblocks 3 and 4 are combined. Alternatively, the encoding apparatus may transform a picture block obtained after picture subblocks 1 and 3 are combined, and transform a picture block obtained after picture subblocks 2 and 4 are combined. Alternatively, the encoding apparatus may transform a picture block obtained after all the M picture subblocks are combined. For example, in the picture block 303 in FIG. 3, the encoding apparatus may transform a picture block obtained after picture subblocks 1, 2, and 3 are combined (namely, the entire picture block 303).

In another embodiment, the transform may be either of the following two methods: if the M picture subblocks are obtained by horizontally splitting the to-be-encoded picture block, transforming a to-be-transformed picture block obtained after N neighboring picture subblocks in the M picture subblocks are vertically combined; or if the M picture subblocks are obtained by vertically splitting the to-be-encoded picture block, transforming a to-be-transformed picture block obtained after N neighboring picture subblocks in the M picture subblocks are horizontally combined. For example, if a block split method of the to-be-encoded picture block is a derivative split corresponding to the picture block 200, combining of the N picture subblocks is to combine neighboring picture subblocks in a vertical direction. If the block split method of the picture block is a derivative split corresponding to the picture block 300, combining of the N picture subblocks is to combine neighboring picture subblocks in a horizontal direction.

It can be learned that in this application, transform is performed on the at least one of the plurality of picture subblocks obtained by splitting the to-be-encoded picture block. In this way, transform performed on the to-be-encoded picture block is flexible and diversified, and complies with a picture feature of the to-be-encoded picture block. This improves picture encoding efficiency.

In an embodiment, the encoding apparatus needs to determine the block split method used for the to-be-encoded picture block; determine, from the three methods, a transform method used for the at least one of the picture subblocks; and add identification information in a bitstream of the picture. The identification information is used to indicate the block split method used for the to-be-encoded picture block and the transform method used for the at least one of the picture subblocks.

As described above, there may be three transform methods used for the at least one of the picture subblocks, and the encoding apparatus needs to determine one of the transform methods as the transform method used for the at least one of the picture subblocks. The determining process may be determining a transform method with a lowest operation cost in the three methods as the transform method used for the at least one of the picture subblocks, or determining, from the three methods and based on a result of comparison between a length and/or a width of the to-be-encoded picture block and a specified threshold, the transform method used for the at least one of the picture subblocks. In this application, the encoding apparatus calculates an operation cost of each of the three methods, and determines the transform method with the lowest operation cost as the transform method used for the at least one of the picture subblocks. For example, for the picture block 108, a cost function (the cost function may be set with reference to factors such as a pixel, a color level, and a grayscale in the picture block, and may also be set with reference to factors such as an amount of data and a quantity of pixels in the picture block; a derivative refinement method and a transform method that are selected based on these reference factors meet the picture feature in the picture block; and then encoding that best complies with the picture feature is implemented) is used to calculate operation costs of transforming the picture block by using the three methods, and the transform method with the lowest operation cost is determined as the transform method used for the at least one of the picture subblocks. Alternatively, the encoding apparatus may compare the length and/or the width of the picture block with the specified threshold. For example, the length or the width of the picture block is greater than M, or a ratio of the length to the width of the picture block is less than 1.5. A transform method corresponding to the determining condition is selected as the transform method used for the at least one of the picture subblocks. There may be another determining condition for comparing the length and/or the width of the to-be-encoded picture block with the specified threshold. This is not specifically limited. Based on the foregoing two methods for determining a transform method, a transform method that best complies with the picture feature of the to-be-encoded picture block can be determined, thereby improving picture encoding efficiency.

Because the encoding apparatus may determine different transform methods for different to-be-encoded picture blocks, the encoding apparatus needs to notify a decoding apparatus of the different transform methods, so that the decoding apparatus can determine an inverse transform method to be used for a corresponding to-be-decoded picture block. In this application, the decoding apparatus and the encoding apparatus may be located on a same picture processing device, or may be located on different picture processing devices. For example, the encoding device is located on a photographing device, the decoding device is located on a video playback device, and the two devices are connected by a network or a cable. Based on this, the encoding apparatus may be synchronized with the decoding apparatus, and transmit an encoded picture bitstream to the decoding apparatus while performing encoding in real time, or transmit an encoded picture bitstream to the decoding apparatus when necessary (for example, when a user requests to watch a video).

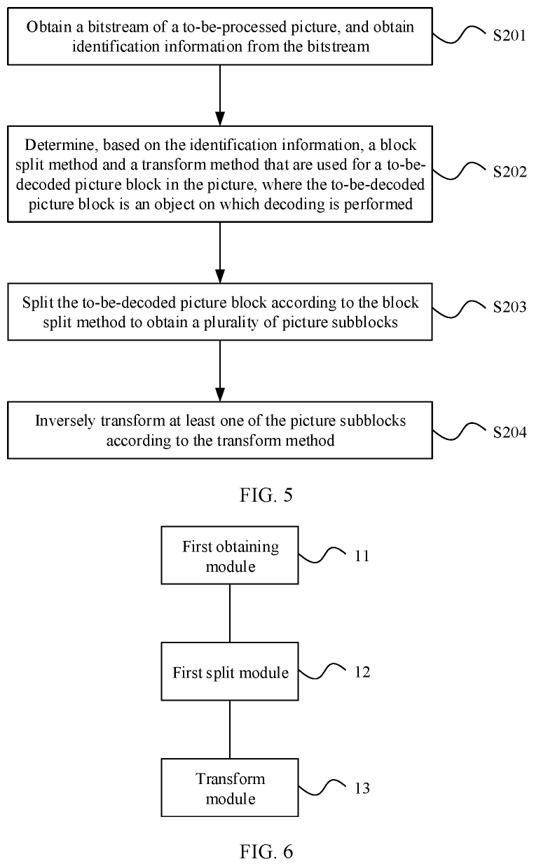

FIG. 5 is a flowchart of an embodiment of an inverse transform method for a picture block according to this application. As shown in FIG. 5, the method in this embodiment is performed by a decoding apparatus, and may include the following steps.

Step S201: Obtain a bitstream of a to-be-processed picture, and obtain identification information from the bitstream.

The decoding apparatus may obtain the bitstream of the to-be-processed picture in a plurality of manners. The bitstream may be obtained in real time or may be extracted at one time.

Step S202: Determine, based on the identification information, a block split method and a transform method that are used for a to-be-decoded picture block in the picture, where the to-be-decoded picture block is an object on which decoding is performed.

Step S203: Split the to-be-decoded picture block according to the block split method to obtain a plurality of picture subblocks.

The block split method performed by the decoding apparatus on the to-be-decoded picture block is determined based on the identification information, and may be any one of block split effects shown in FIG. 3.

Step S204: Inversely transform at least one of the picture subblocks according to the transform method.

Inverse transform performed by the decoding apparatus on the to-be-decoded picture block corresponds to transform performed by the encoding apparatus on the to-be-encoded picture block. A principle of an inverse transform process of the decoding apparatus is similar to a principle of a transform process of the encoding apparatus, and details are not described herein again.

In this application, inverse transform is performed on the at least one of the plurality of picture subblocks obtained by splitting the to-be-decoded picture block. In this way, inverse transform performed on the to-be-decoded picture block is flexible and diversified, and complies with a picture feature of the to-be-decoded picture block. This improves picture decoding efficiency.

FIG. 6 is a schematic structural diagram of Embodiment 1 of an encoding apparatus according to this application. As shown in FIG. 6, the apparatus in this embodiment may include a first obtaining module 11, a first split module 12, and a transform module 13. The first obtaining module 11 is configured to obtain a to-be-encoded picture block in a to-be-processed picture, where the to-be-encoded picture block is an object on which encoding is performed. The first split module 12 is configured to split the to-be-encoded picture block to obtain a plurality of picture subblocks. The transform module 13 is configured to transform at least one of the picture subblocks.

Based on the foregoing technical solution, the first split module 12 is specifically configured to split the to-be-encoded picture block to obtain M picture subblocks, where M is an integer greater than 1. The transform module 13 is specifically configured to transform a to-be-transformed picture block obtained after N neighboring picture subblocks in the M picture subblocks are combined, where N is an integer less than or equal to M and greater than or equal to 1.

Based on the foregoing technical solution, the transform module 13 is specifically configured to perform any one of the following three methods: transforming each of the M picture subblocks; transforming a to-be-transformed picture block obtained after at least two of the M picture subblocks are combined; or transforming a to-be-transformed picture block obtained after all the M picture subblocks are combined.

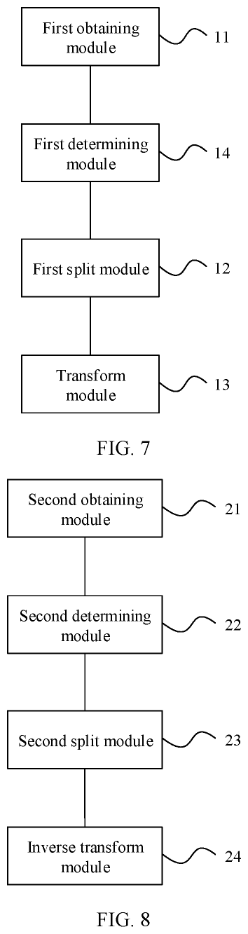

Based on the foregoing technical solution, FIG. 7 is a schematic structural diagram of Embodiment 2 of the encoding apparatus according to this application. As shown in FIG. 7, the apparatus in this embodiment may further include a first determining module 14, configured to determine a block split method used for the to-be-encoded picture block, and determine, from the three methods, a transform method used for the at least one of the picture subblocks.

Based on the foregoing technical solution, the first determining module 14 is further configured to add identification information in a bitstream of the picture. The identification information is used to indicate the block split method used for the to-be-encoded picture block and the transform method used for the at least one of the picture subblocks.

Based on the foregoing technical solution, the first split module 12 is specifically configured to vertically split the to-be-encoded picture block to obtain the plurality of picture subblocks, and/or horizontally split the to-be-encoded picture block to obtain the plurality of picture subblocks.

Based on the foregoing technical solution, the first determining module 14 is specifically configured to determine a method with a lowest operation cost in the three methods as the transform method used for the at least one of the picture subblocks.

Based on the foregoing technical solution, the first determining module 14 is specifically configured to determine, from the three methods and based on a result of comparison between a length and/or a width of the to-be-encoded picture block and a specified threshold, the transform method used for the at least one of the picture subblocks.

The apparatus in this embodiment may be used to execute the technical solutions of the method embodiment shown in FIG. 4. The implementation principles and technical effects are similar, and are not further described herein.

FIG. 8 is a schematic structural diagram of an embodiment of a decoding apparatus according to this application. As shown in FIG. 8, the apparatus in this embodiment may include a second obtaining module 21, a second determining module 22, a second split module 23, and an inverse transform module 24. The second obtaining module 21 is configured to obtain a bitstream of a to-be-processed picture, and obtain identification information from the bitstream. The second determining module 22 is configured to determine, based on the identification information, a block split method and a transform method that are used for a to-be-decoded picture block in the picture, where the to-be-decoded picture block is an object on which decoding is performed. The second split module 23 is configured to split the to-be-decoded picture block according to the block split method to obtain a plurality of picture subblocks. The inverse transform module 24 is configured to inversely transform at least one of the picture subblocks according to the transform method.

Based on the foregoing technical solution, the second split module 23 is specifically configured to split the to-be-decoded picture block according to the block split method to obtain M picture subblocks, where M is an integer greater than 1; and the inverse transform module 24 is specifically configured to inversely transform, according to the transform method, a to-be-inversely transformed picture block obtained after N neighboring picture subblocks in the M picture subblocks are combined, where N is an integer less than or equal to M and greater than or equal to 1.

Based on the foregoing technical solution, the inverse transform module 24 is specifically configured to perform any one of the following three methods: inversely transforming each of the M picture subblocks; inversely transforming a to-be-inversely transformed picture block obtained after at least two of the M picture subblocks are combined; or inversely transforming a to-be-inversely transformed picture block obtained after all the M picture subblocks are combined.

Based on the foregoing technical solution, the second split module 23 is specifically configured to perform any one of the following three methods: vertically splitting the to-be-decoded picture block to obtain the plurality of picture subblocks; horizontally splitting the to-be-decoded picture block to obtain the plurality of picture subblocks; or vertically and horizontally splitting the to-be-decoded picture block to obtain the plurality of picture subblocks.

Based on the foregoing technical solution, the inverse transform module 24 is specifically configured to perform either of the following two methods: when the M picture subblocks are obtained by horizontally splitting the picture block, inversely transforming a to-be-inversely transformed picture block obtained after N neighboring picture subblocks in the M picture subblocks are vertically combined; or when the M picture subblocks are obtained by vertically splitting the picture block, inversely transforming a to-be-inversely transformed picture block obtained after N neighboring picture subblocks in the M picture subblocks are horizontally combined.

The apparatus in this embodiment may be used to execute the technical solutions of the method embodiment shown in FIG. 5. The implementation principles and technical effects are similar, and are not further described herein.

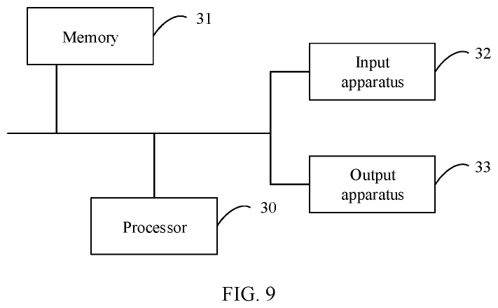

FIG. 9 is a schematic structural diagram of an embodiment of a picture processing device according to this application. As shown in FIG. 9, the picture processing device includes a processor 30, a memory 31, an input apparatus 32, and an output apparatus 33. There may be one or more processors 30 in the picture processing device. In FIG. 9, one processor 30 is used as an example. The processor 30, the memory 31, the input apparatus 32, and the output apparatus 33 in the picture processing device may be connected by using a bus or in another manner. In FIG. 9, an example in which the processor 30, the memory 31, the input apparatus 32, and the output apparatus 33 are connected by using a bus is used.

As a computer-readable storage medium, the memory 31 may be configured to store a software program, a computer-executable program, and a module, for example, a program instruction/module corresponding to the method in the embodiment shown in FIG. 4 or FIG. 5 in this application. The processor 30 runs the software program, the instruction, and the module that are stored in the memory 31, to execute various function applications of the picture processing device and performs data processing, that is, to implement the foregoing method.

The memory 31 may mainly include a program storage area and a data storage area. The program storage area may store an operating system and an application program required by at least one function. The data storage area may store data created based on use of a terminal, and the like. In addition, the memory 31 may include a high-speed random access memory, and may further include a non-volatile memory, for example, at least one magnetic disk storage device, a flash memory device, or another non-volatile solid-state storage device. In some examples, the memory 31 may further include a memory that is remotely disposed for the processor 30, and the remote memory may be connected to the picture processing device through a network. Examples of the foregoing network include but are not limited to the internet, an intranet, a local area network, a mobile communications network, and a combination thereof.

The input apparatus 32 may be configured to: receive input digit or character information, and generate a key signal input related to a user setting and function control of the picture processing device. The output apparatus 33 may include a display device such as a display screen.

In an embodiment, this application provides a computer-readable storage medium. The computer-readable storage medium stores instructions, and when the instructions are run on a computer, the instructions are used to perform the method embodiment shown in FIG. 4 or FIG. 5.

In an embodiment, this application provides a computer program. When the computer program is executed by a computer, the computer program is used to perform the method embodiment shown in FIG. 4 or FIG. 5.

A person of ordinary skill in the art may understand that all or some of the steps in the foregoing method embodiments may be implemented by program-instructing related hardware. The program may be stored in a computer-readable storage medium. When the program is executed, the steps in the foregoing method embodiments are performed. The foregoing storage medium includes any medium that can store program code, such as a ROM, a RAM, a magnetic disk, or an optical disc.

Finally, it should be noted that the foregoing embodiments are merely intended for describing the technical solutions of this application other than limiting this application. Although this application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of this application.

What is claimed is:

1. An inverse transform method for a picture block, the method comprising:
obtaining a bitstream of a to-be-processed picture, and obtaining identification information from the bitstream;
determining, based on the identification information, a block split method and a transform method that are used for a to-be-decoded picture block in the picture, wherein the to-be-decoded picture block is an object on which decoding is performed;
splitting the to-be-decoded picture block according to the block split method to obtain a plurality of picture subblocks; and
inversely transforming at least one of the plurality of picture subblocks according to the transform method.

2. The method according to claim 1, wherein the splitting the to-be-decoded picture block according to the block split method to obtain a plurality of picture subblocks comprises:
splitting the to-be-decoded picture block according to the block split method to obtain M picture subblocks, wherein M is an integer greater than 1; and
the inversely transforming at least one of the plurality of picture subblocks according to the transform method comprises:
inversely transforming, according to the transform method, a to-be-inversely transformed picture block obtained after N neighboring picture subblocks in the M picture subblocks are combined, wherein N is an integer less than or equal to M and greater than or equal to 1.

3. The method according to claim 2, wherein the inversely transforming, according to the transform method, a to-be-inversely transformed picture block obtained after N neighboring picture subblocks in the M picture subblocks are combined is any one of the following three methods:
inversely transforming each of the M picture subblocks;
inversely transforming a to-be-inversely transformed picture block obtained after at least two of the M picture subblocks are combined; or
inversely transforming a to-be-inversely transformed picture block obtained after all the M picture subblocks are combined.

4. The method according to claim 2, wherein the splitting the to-be-decoded picture block according to the block split method to obtain a plurality of picture subblocks is any one of the following three methods:
vertically splitting the to-be-decoded picture block to obtain the M picture subblocks;
horizontally splitting the to-be-decoded picture block to obtain the M picture subblocks; or
vertically and horizontally splitting the to-be-decoded picture block to obtain the M picture subblocks.

5. The method according to claim 4, wherein the inversely transforming at least one of the picture subblocks according to the transform method is either of the following two methods:
when the M picture subblocks are obtained by horizontally splitting the to-be-decoded picture block, inversely transforming a to-be-inversely transformed picture block obtained after N neighboring picture subblocks in the M picture subblocks are vertically combined; or
when the M picture subblocks are obtained by vertically splitting the to-be-decoded picture block, inversely transforming a to-be-inversely transformed picture block obtained after N neighboring picture subblocks in the M picture subblocks are horizontally combined.

6. An encoding apparatus, comprising:
at least one processor; and
a memory storing computer executable instructions for execution by the at least one processor, wherein the computer executable instructions instruct the at least one processor to:
obtain a to-be-encoded picture block in a to-be-processed picture, wherein the to-be-encoded picture block is an object on which encoding is performed;
split the to-be-encoded picture block to obtain a plurality of picture subblocks; and
transform at least one of the plurality of picture subblocks.

7. The apparatus according to claim 6, wherein the computer executable instructions further instruct the at least one processor to split the to-be-encoded picture block to obtain M picture subblocks, wherein M is an integer greater than 1; and
transform a to-be-transformed picture block obtained after N neighboring picture subblocks in the M picture subblocks are combined, wherein N is an integer less than or equal to M and greater than or equal to 1.

8. The apparatus according to claim 7, wherein the computer executable instructions further instruct the at least one processor to implement one of three methods:
transform each of the M picture subblocks;
transform a to-be-transformed picture block obtained after at least two of the M picture subblocks are combined; and
transform a to-be-transformed picture block obtained after all the M picture subblocks are combined.

9. The apparatus according to claim 8, wherein the computer executable instructions further instruct the at least one processor to determine a block split method used for the to-be-encoded picture block, and determine, from the three methods, a transform method used for the at least one of the picture subblocks.

10. The apparatus according to claim 9, wherein the computer executable instructions further instruct the at least one processor to add identification information in a bitstream of the picture, wherein the identification information is used to indicate the block split method used for the to-be-encoded picture block and the transform method used for the at least one of the picture subblocks.

11. The apparatus according to claim 6, wherein the computer executable instructions further instruct the at least one processor to one or both of i) vertically split the to-be-encoded picture block to obtain the plurality of picture subblocks, and ii) horizontally split the to-be-encoded picture block to obtain the plurality of picture subblocks.

12. The apparatus according to claim 9, wherein the computer executable instructions further instruct the at least one processor to determine a method with a lowest operation cost in the three methods as the transform method used for the at least one of the picture subblocks.

13. The apparatus according to claim 9, wherein the computer executable instructions further instruct the at least one processor to determine, from the three methods and based on a result of comparison between one or both of a length and a width of the to-be-encoded picture block and a specified threshold, the transform method used for the at least one of the picture subblocks.

14. A decoding apparatus, comprising:
at least one processor; and
a memory storing computer executable instructions for execution by the at least one processor, wherein the computer executable instructions instruct the at least one processor to:
obtain a bitstream of a to-be-processed picture, and obtain identification information from the bitstream;
determine, based on the identification information, a block split method and a transform method that are used for a to-be-decoded picture block in the picture, wherein the to-be-decoded picture block is an object on which decoding is performed;
split the to-be-decoded picture block according to the block split method to obtain a plurality of picture subblocks; and
inversely transform at least one of the plurality of picture subblocks according to the transform method.

15. The apparatus according to claim 14, wherein the computer executable instructions further instruct the at least one processor to split the to-be-decoded picture block according to the block split method to obtain M picture subblocks, wherein M is an integer greater than 1; and
wherein the computer executable instructions further instruct the at least one processor to inversely transform, according to the transform method, a to-be-inversely transformed picture block obtained after N neighboring picture subblocks in the M picture subblocks are combined, wherein N is an integer less than or equal to M and greater than or equal to 1.

16. The apparatus according to claim 15, wherein the computer executable instructions further instruct the at least one processor to perform any one of the following three methods:
inversely transforming each of the M picture subblocks;
inversely transforming a to-be-inversely transformed picture block obtained after at least two of the M picture subblocks are combined; and
inversely transforming a to-be-inversely transformed picture block obtained after all the M picture subblocks are combined.

17. The apparatus according to claim 15, wherein the computer executable instructions further instruct the at least one processor to perform any one of the following three methods:
vertically splitting the to-be-decoded picture block to obtain the plurality of picture subblocks;
horizontally splitting the to-be-decoded picture block to obtain the plurality of picture subblocks; and
vertically and horizontally splitting the to-be-decoded picture block to obtain the plurality of picture subblocks.

18. The apparatus according to claim 17, wherein the computer executable instructions further instruct the at least one processor to perform either of the following two methods:
when the M picture subblocks are obtained by horizontally splitting the picture block, inversely transforming a to-be-inversely transformed picture block obtained after N neighboring picture subblocks in the M picture subblocks are vertically combined; or
when the M picture subblocks are obtained by vertically splitting the picture block, inversely transforming a to-be-inversely transformed picture block obtained after N neighboring picture subblocks in the M picture subblocks are horizontally combined.
